(19) United States
(12) Patent Application Publication
(10) Pub. No.: US 2011/0320371 A1
(43) Pub. Date: Dec. 29, 2011

(54) Appointment-offer-notification system and method

(76) Inventors: Nilufer Nober Emek, Syosset, NY (US); Ismail Emek, Syosset, NY (US); Tanner Emek, Syosset, NY (US)

(21) Appl. No.: 12/803,396

(22) Filed: Jun. 25, 2010

(51) Int. Cl. G06Q 50/00

(52) U.S. Cl. 705/313

(57) ABSTRACT

A method for managing multiple listing service (MLS) communications relating to real estate property listings includes managing a network of computers associated with MLS member to enable member access to a repository of information for real estate properties listed under contract with the MLS where listings for real estate property are received from a sending broker or agent network computer, the listing is linked the sending broker or agent, the listing information is deposited in the repository to render the listing information network accessible, any and all electronic communications relating to the listed real estate property are directed to the listing broker or agent linked to the listing and if the listing agent or broker does not respond to an electronic request for an appointment to view the listed real estate property or request to consider a bone fide offer to purchase the listed real estate property, the request is redirected to the owner of the listed property.

### FIELD OF THE INVENTION

The present invention relates to real estate and multiple listing services broadly and, more particularly relates to a system and method for automatically notifying a seller of real property under contract with a multiple listing service that a bid by an intended purchaser of the real property has been tendered.

### BACKGROUND OF THE INVENTION

Property owners contract with real estate brokers and their agents to list and sell, rent or lease their property (i.e., a listing agreement). Today, most real estate brokers and agents utilize a multiple listing service (“MLS”) in order to advertise or otherwise make the availability of listed properties known to other brokers/agents. A MLS is a suite of services that enables and facilitates cooperation with broker participants by accumulating and then disseminating information including listing information to better serve the broker as listing agent for a particular property. This has a collateral effect of better serving the property owner contracting for the broker's services.

One of the primary purposes of an MLS is to provide a facility to publish a “unilateral offer of compensation” by a listing broker or the broker's agent, to other broker participants in that MLS. The listing broker/agent will typically utilize an MLS database and software to widely share information about the seller's property with other agents who may have been contacted by a potential buyer or wish to cooperate with a seller broker in finding a buyer for the property.

In the residential real estate industry, computerized real estate multiple listing service (MLS) databases are the primary source of centralized real estate property listing information, and enjoy widespread acceptance throughout the industry. An MLS database contains a set of property listing records describing real estate properties offered for sale, leasing, or rental for a defined geographic region. Each listing identifies and describes the various characteristics of the property in a standard, pre-defined format, which can be easily and accurately searched. MLS subscribers search the MLS system (e.g., database) and retrieve information about all homes (i.e., properties) for sale by all participating brokers.

U.S. Pat. No. 7,430,555 discloses a system and method for transacting retrieval of real estate property listings using a remote client interfaced over an information network. The listings are maintained in a structured database (an MLS database), wherein each listing includes characteristics describing the property organized according to property class. Remote clients interface in dynamic search sessions via a communications link transiently connected over an information network, i.e., the Internet. The remote client inputs target characteristics and listings matching the target characteristics from the structured database are identified and provided to the remote client upon termination of the session.

U.S. Pat. No. 7,454,355 discloses a method and system for providing real-estate information using a computer network, i.e., the Internet. The system provides buyer information web pages showing relevant buyer list information in particular formats for access by MLS participating real estate agents (i.e., an MILS database). The information typically includes potential buyer name, new activity summaries for newly-listed properties and other activity meeting buyer profiles, new summaries of detailed property information by the buyer. Also provided is a comparative market analysis (CMA) list web page showing relevant CMA information.

The listing data stored in an MLS database is the proprietary information of the broker who has obtained the listing agreement with a property's seller. Most MLS systems restrict membership and access to real estate brokers (and their agents) who are appropriately licensed by the state (or province), are members of a local board or association of realtors or members of a real estate trade association (e.g., NAR or CREA). The National Association of Realtors (NAR) has set policies that permit brokers to show limited MLS information on their websites under a system known as “IDX” or “Internet Data Exchange”. Using IDX search tools, potential buyers view properties available on the market. If a potential buyer finds a property, he/she must contact the listing broker (going through their own seller's agent) to view the house and make an offer.

If the broker/agent with the listing agreement carries out the actual sale without a co-broker or agent, the listing broker keeps the entire commission or fee. If a co-broker or agent produces a buyer for a listed property, the listing broker/agent is compelled to share the fee or commission with the co-broker, in accordance with the listing broker's contract with the MLS. Sometimes, however, offers for sale to listing brokers from interested buyers or agents associated with the buyer intentionally are not communicated to the seller. That is, the listing broker, or its agent, in an effort to maintain a bigger part of the overall fee that the seller pays, will not communicate bona fide offers for sale received from other co-brokers or co-agents to instead wait for an alternative offer by direct buyer. If the listing broker or agent makes the sale directly to a buyer, he/she does not have to split the fee.

Conventionally, a co-broker (agent) with a potential buyer for a listed property must first contact the listing broker/agent to arrange an appointment for the potential buyer to view the property. Where the potential buyer sees the property and wishes to make a purchase offer, the offer to purchase must be indirectly made though the co-broker (agent). This is typically set forth in the terms MLS agreements to which both the broker/agent and the co-broker (agent) are bound.

While the listing broker/agent has an obligation to communicate such offers to the seller, unscrupulous listing broker/agents are known to intentionally fail to communicate outstanding offers to purchase in order that they themselves might find a purchaser on their own, obviating a need to split the commission for the sale with a co-broker (agent). So in view of the co-broker's contractual obligation to not contact the seller directly, the seller is at the mercy of the listing broker/agent. Such practice is not only unfair and frustrating to the co-broker (agent) and potential purchaser, but is likely a violation of the listing broker's ethical duty and contractual obligations.

### SUMMARY OF THE INVENTION

The present invention provides an automatic appointment-offer-notification method and system for automatically communicating offers from potential buyer of property in cooperation with known MLS and like systems (e.g., REBNY) and/or as an improvement to a known MLS and/or a like system.

In one embodiment, an appointment-offer-notification (AON) method is operable in a processor/server for managing multiple listing service (MLS) communications relating to an exchange of real estate property listing information. The AON method includes interconnecting and managing a network of computers associated with MLS member real estate brokers and agents to enable MLS member access to a repository of real estate property listing information for real estate properties listed under contract with the MLS for sale, rent or lease and receiving a listing for a real estate property to sell, rent or lease from a sending broker or agent network computer.

The AON method further includes linking the listing to the broker or agent associated with said sending network computer that has contracted with an owner of real estate property listed, depositing listing information related to the listed real estate property in the repository to render the listing information network accessible, directing any and all electronic communications relating to the listed real estate property to the listing broker or agent linked to the listing and, if the listing agent or broker does not respond to an electronic request for an appointment to view the listed real estate property or request to consider a bone fide offer to purchase the listed real estate property, redirecting said request to the owner of the listed property.

In an alternative embodiment, a method of operating a real estate multiple listing service (MLS) including an appointment-offer-notification (AON) function, implemented by a processor server, includes maintaining a multiple listing service (MLS) database to store and make accessible listing information on real estate properties listed with the MLS, interconnecting a plurality of computers associated with real estate brokers and agents doing business with an MLS, wherein each computer is authorized to search and access listing information on real estate properties in the database and receiving a listing for a real estate property for sale, rent or lease from real estate a broker/agent for listing with the MLS, and linking the listing broker/agent to both the real property and an owner of the real property using one of a broker/agent identifier and an owner/property identifier.

Any and all electronic communications relating to the listed real estate property are directed to the listing broker/agent linked to the listing by the broker/agent identifier or the owner/property identifier. Electronic communications directed to the listing broker/agent that either request an appointment to show the listed property or include a bona fide offer to purchase are automatically recognized and sent concurrently to the owner of the listed property.

In another embodiment, the invention comprises an electronic appointment-offer-notification system (AONS), comprising a processor and memory operable as a processor/server for managing multiple listing service (MLS) communications relating to an exchange of real estate property listing information. The AONS includes a network management function that maintains and manages a network of computers associated with MLS member real estate brokers and agents including enabling access to a repository of real estate property listing information for real estate properties listed under contract with the MLS for sale, rent or lease and an MLS property listing function for receiving a listing for a real estate property to sell, rent or lease from an MLS member sending broker or agent network computer and linking the listing to the broker or agent associated with said sending network computer who contracted with the real property owner.

A database function that enables depositing listing information related to the real estate property listing in the repository and rendering the listing information network accessible, a communications function that directs any and all electronic communications relating to the listed real estate property to the listing broker or agent linked to the listing and an electronic appointment-offer-notification (AON) function that monitors all electronic communications and operates in one of a first mode of operation and a second mode of operation.

In the first mode of operation, the AON function operates to detect that a listing agent or broker has not responded to an electronic communication requesting an appointment to view the listed real estate property or presenting a bone fide offer to purchase the listed real estate property, and in response automatically electronically communicates said communication directly to the owner of the listed property and in the second mode of operation, the AON function operates to automatically detect electronic communications to a listing agent or broker that either request an appointment to view the listed real estate property or present a bona fide offer to purchase the listed real estate property, and in response automatically electronically send said communication to the owner of the listed property.

A computer program product including a processor and a set of processor readable instructions that when executed by the processor execute an appointment-offer-notification (AON) method for managing multiple listing service (MLS) communications relating to an exchange of real estate property listing information. The method includes interconnecting and managing a network of computers associated with MLS member real estate brokers and agents to enable MILS member access to a repository of real estate property listing information for real estate properties listed under contract with the MLS for sale, rent or lease, receiving a listing for a real estate property to sell, rent or lease from a sending broker or agent network computer and linking the listing to the broker or agent associated with said sending network computer that has contracted with an owner of real estate property listed.

The method further includes depositing listing information related to the listed real estate property in the repository to render the listing information network accessible, directing any and all electronic communications relating to the listed real estate property to the listing broker or agent linked to the listing; and one of: wherein if the listing agent or broker does not respond to an electronic communication either requesting an appointment to view the listed real estate property or requesting a bona fide offer to purchase the listed real estate property, automatically recognizing and redirecting said electronic communication request directly to the owner of the listed property, and wherein electronic communications directed to the listing broker/agent that either request an appointment to show the listed property or include a bona fide offer to purchase the listed property are automatically recognized and sent concurrently to the owner of the listed property.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a system-level diagram depicting an embodiment of a network-based electronic appointment-offer-notification system (AONS) 100, of the invention;

FIG. 2 is a schematic diagram depicting an embodiment of a processor/server that may be used in the network based AONS of FIG. 1;

FIG. 3A is a schematic flow diagram depiction an embodiment of an appointment-offer-notification (AON) method of operating according to the invention;

FIG. 3B is a portion of a schematic flow diagram that discloses an alternative to the FIG. 3A method of notifying an owner of listing-related communications;

FIG. 4 is schematic depiction of a signal-bearing storage media in a form of a magnetic data storage diskette 400 for storing instructions for execution by a processor/server CPU to implement the FIG. 3 method; and

FIG. 5 is functional clock diagram depicting an electronic appointment-offer-notification system (AONS).

### DETAILED DESCRIPTION OF THE INVENTION

The following is a detailed description of example embodiments of the invention depicted in the accompanying drawings. The example embodiments are in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

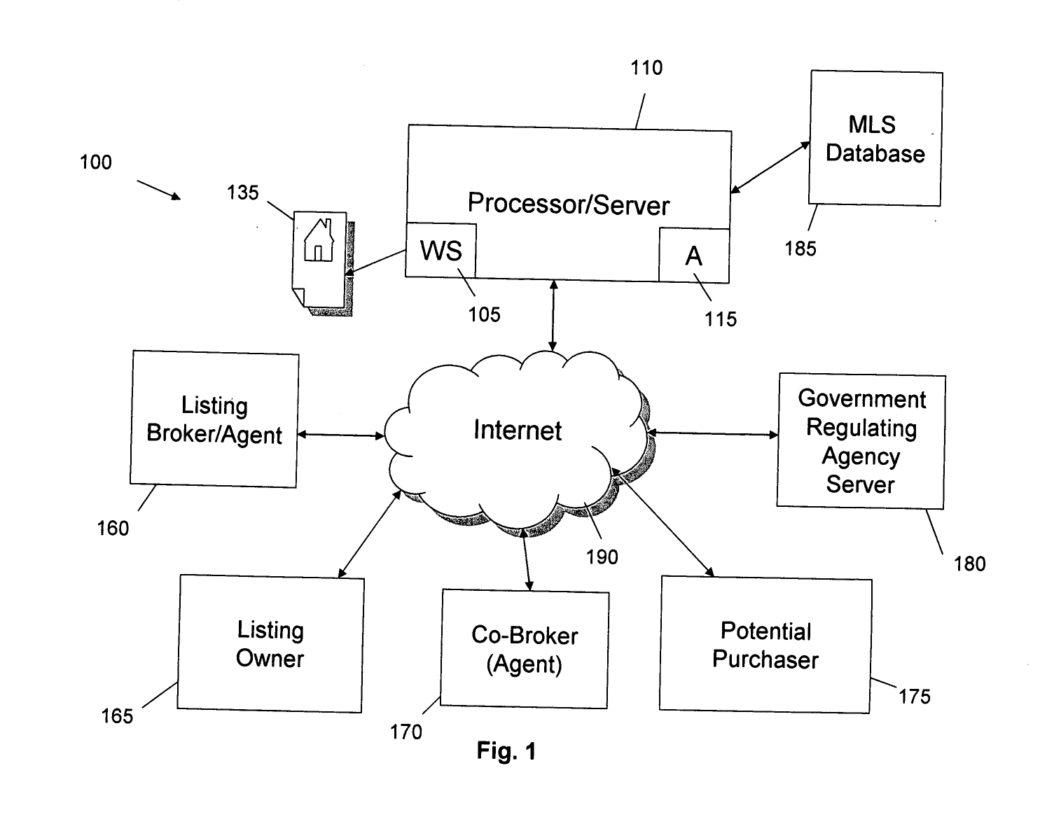

FIG. 1 is a diagram of one embodiment of an appointment-offer-notification system (AONS) 100 of the invention. AONS system 100 is shown to include a processor/server 110 connected to the Internet 190. Processor/server 110 comprises or operates a web site (WS) 105 and various databases, communications, and other applications (A) 115, which together carry out or execute processes embodying a method of operating according to the invention. Web site (WS) 105 presents or serves web pages 135, which may include both static web pages and dynamic web pages. Static web pages comprise web page files that are consistently available at the web site (WS) 105 on the processor/server 110 and dynamic web pages comprise web page files generated by one or more of the applications (A) 115 though access of one or more databases.

The processor/server 110 and web site (WS) 105 is/are shown in communication with a computer 160 accessible by real estate broker or the broker's agent (hereinafter “broker/agent”) who lists a property for sale or lease under agreement with an owner and a computer 165 accessible by the owner listing the property via the Internet 190. The processor/server 110 and web site (WS) 105 also are in communication with a computer 170 accessible by real estate co-broker (agent) and a computer 175 accessible by a potential purchaser of the listed property, via the Internet 190. The pages 135 comprising the website (WS) 105 (served by processor/server 110) are viewable by Internet browsers (e.g., Microsoft Internet Explorer or Netscape Navigator) residing on the computers 160, 165, 170, 175.

While the elements 160, 165, 170 and 175 are used to identify the listing broker/agent, the listing owner, the co-broker (agent) and potential purchaser computers, they are used interchangeably herein in order also to designate the actual listing broker/agent, the listing owner, the co-broker (agent) and the potential purchaser.

The processor/server 110 also is shown in communication with a multiple listing service (MLS) database (or like database, e.g., REBNY) of real estate data 185. MLS database 185 contains information on listed and previously listed properties, but does not normally include the name of potential purchasers. MLS database 185 can be connected to processor/server 110 using any conventional means such as wireless or Ethernet connection. It should be understood, however, that while the processor/server 110 is shown connected directly to the MLS database 185, it is envisioned that the database can be connected indirectly, for example, Intranetwork, or Internetwork, where the database 185 is not proximate and directly accessible to processor/server 110. For that matter, while MLS database 185 is shown to comprise a single repository of real estate information, it is not limited thereto, but may comprise a set of related by distributed memory systems (distributed either Intranetwork or Internetwork), without deviating from the scope and spirit of the invention.

The processor/server 110 periodically accesses the MLS database 185 to retrieve updated information and provides the updated information (if available) to its databases, communications, and other applications (A) 115. The processor/server 110 makes the information available to listing owner(s) 165, potential purchaser(s) 175, broker/agent(s) 160 and co-broker (agent) 170. For example, a listing owner 165 or potential purchaser 175 may access or be provided with access to search results showing property information found per search criteria entered by a broker/agent 160 or co-broker (agent) 170, and saved. Results for same are updated when the listing owner 165 or potential purchaser 175 logs into the web site (WS) 105 and activates a request (e.g., by a clicking on a hyperlink). The listing owner 165 or potential purchaser 175 may directly search by entering search criteria (e.g., price range, minimum number of bedrooms, minimum number of bathrooms, and minimum square footage), to receive a list of properties meeting the search criteria, and to view detailed property information in relation to the properties on a selected list.

The broker/agent for the listing owner 165 or potential purchaser 175 provides the potential purchaser with access to the online property information. While accessed, the listing owner 165 or potential purchaser 175 activities are monitored and recorded including any detailed property information for a particular property view. A broker/agent uses the broker/agent's computer 160 to log onto the web site (WS) 105 using a user name and password assigned to the broker/agent.

Upon receiving the log-in name and password from the broker/agent's computer 160, or a co-broker (agent) computer 170, the processor/server 110 examines the name and password to determine if they are valid. If so, the processor server 110 allows the broker/agent's computer 160 or a co-broker (agent) computer 170 to access the web site (WS) 105. In the embodiment shown, the processor/server 110 determines that the user name and password are valid, and allows access to the web site (WS) 105. Alternatively, the processor/server 110 can first communicate to an official governmental licensing authority, such as at a governmental regulating agency server 180 as shown, to first determine that the broker/agent or co-broker (agent) is licensed and in good standing before allowing access to the web site (WS) 105

On receiving an indication that the broker/agent's computer 160, or a co-broker (agent) computer 170 would like to access a purchaser list, or a particular listed property, the processor/server 110 provides the purchaser list to the broker/agent's computer 160, or a co-broker (agent) computer 170 in the form of a purchaser information web page. The processor/server 110 does so by accessing the databases (A) 115, or the MLS database 185, having information associated with the broker/agent's computer 160, or a co-broker (agent) computer 170 and the listing owner 165 or potential purchaser 175 on the broker/agent's computer 160, or a co-broker (agent) computer 170 purchaser list, constructing a purchaser information web page according to a pre-stored format, and sending the purchaser information web page to the broker/agent's computer 160, or a co-broker (agent) computer 170.

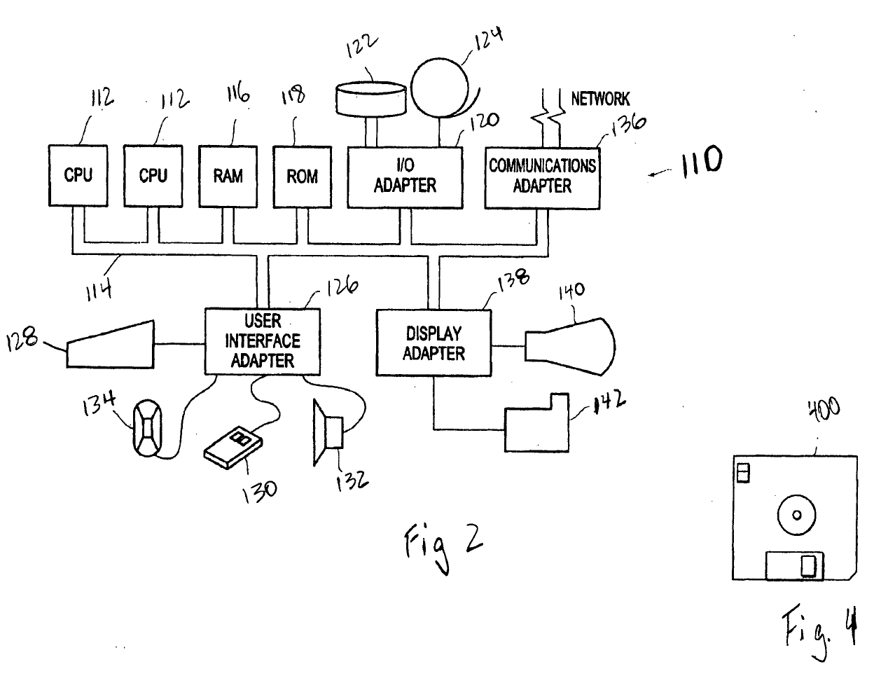

FIG. 2 illustrates a typical hardware configuration of AONS processor/server 110 in accordance with the invention and which preferably has at least one processor or central processing unit (CPU) 112. CPUs 112 are interconnected via a system bus 114 to a random access memory (RAM) 116, read-only memory (ROM) 118, input/output (I/O) adapter 120 (for connecting peripheral devices such as disk units 122 and tape drives 124 to the bus 114), user interface adapter 126 (for connecting a keyboard 128, mouse 130, speaker 132, microphone 134, and/or other user interface device to the bus 114), a communications adapter 136 for connecting an information handling system to a data processing network (either wireline or wireless), the Internet, an Intranet, a personal area network (PAN), etc., and a display adapter 138 for connecting the bus 114 to a display device 140 and/or printer 142 (e.g., a digital printer or the like).

In addition to the hardware/software environment described above, a different aspect of the invention includes a computer-implemented method for performing the above method. As an example, this method may be implemented in the particular environment discussed above. Such a method may be implemented, for example, by operating a computer, as embodied by a digital data processing apparatus, to execute a sequence of machine-readable instructions. These instructions may reside in various types of signal-bearing storage media.

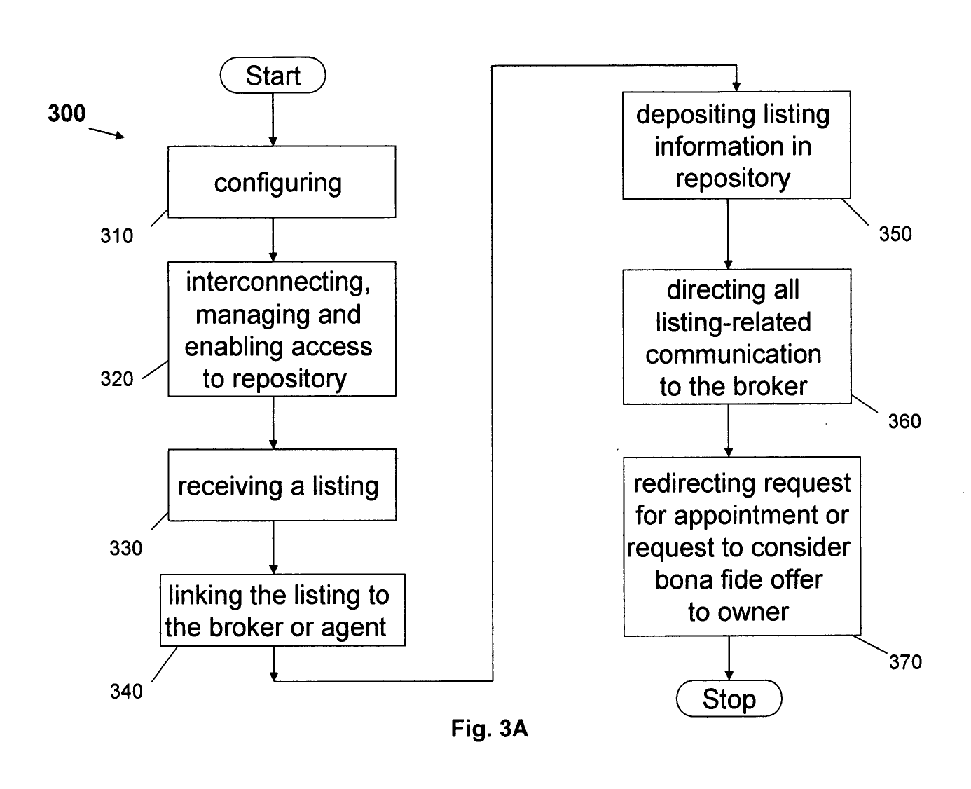

FIG. 3 illustrates an embodiment of an appointment-offer-notification (AON) method of the invention (300). The AON method is operable in a processor/server 110, and manages multiple listing service (MLS) communications relating to an exchange of real estate property listing information.

The AONS and processor/server must first be configured for its particular network application to reflect all of the MLS policy and rules for communicating, as know to those of skill in the art. This is represented as a step of configuring, 310. The AON method includes interconnecting and managing a network of computers associated with MLS member real estate brokers and their agents, and co-brokers (agent) assisting potential purchaser to enable MLS member access (all participating brokers and agents and co-brokers and agents) to a repository of real estate property listing information for real estate properties listed under contract with the MLS for sale, rent or lease. This is represented as a step of interconnecting, managing and enabling access to repository, 320.

The AON method includes receiving a listing for a real estate property to sell, rent or lease from a sending broker or agent network computer, represented in the step of receiving a listing, 330; linking the listing to the broker or agent associated with said sending network computer that has contracted with an owner of real estate property listed, represented by the step of linking the listing to the broker or agent, 340; and depositing listing information related to the listed real estate property in the repository to render the listing information network accessible, represented by the step of depositing listing information in repository, 350.

The AON method further includes directing any and all electronic communications relating to the listed real estate property to the listing broker or agent linked to the listing, represented by the step of directing all listing-related communication to the broker/agent, 360. In a first embodiment, where the listing agent or broker does not respond to an electronic request for an appointment to view the listed real estate property or request to consider a bone fide offer to purchase the listed real estate property, redirecting or resubmitting the request for appointment or the request to consider bona fide offer to the owner, represented by the step of 370.

Alternatively, where listing-related communications requesting an appointment or making a bona fide offer to purchase are sent to the listing broker/agent, instead of only notifying the seller/owner where the listing broker agent is non-responsive only at the occurrence of a condition, i.e., one or two days, either one or both of such particular-type communications are automatically recognized and sent concurrently by the system to both the listing broker/agent and the listing owner. This way the listed property owner in not merely notified of a request to show or bona fide offer for sale after a fixed time period, but immediately (concurrently) with these communications to the listing broker/agent. This alternative step is shown in FIG. 3B and identified as step 380, where step 380 would replace step 370 in the FIG. 1B embodiment.

The interconnecting and managing includes creating accounts for the broker or agent seeking to become an MLS member, and preferably, the creating includes communicating with a server for a governmental agency empowered to regulate and license real estate brokers and agents in order to verify that the broker or agent seeking MLS membership is licensed and in good standing. In an alternative method option, the creating includes assigning an MLS broker or agent identifier to the real estate broker or agent account.

The linking includes assigning the MLS broker or agent identifier to the linked listing, or alternatively includes a assigning an owner/property identifier to the linked listing that identifies the owner under contract, the real estate property and the broker or agent. In the first described embodiment, the redirecting a request for appointment, a request to consider a bone fide offer to purchase or to send a letter (electronic) of intent directly to the owner is implemented in any number of conditions, including where the listing agent fails to respond after 24 hours, after 48 hours, after two received requests in a 24 or 48 hour period, after three repeated requests, etc., depending of the MLS policy for which the network id configured for operation.

Preferably, the redirecting includes generating a return notification upon delivery of any and all communications to the listing real estate broker or agent or generating a return notification upon delivery of any and all communications to the mail box of the listing real estate broker or agent in accordance with the MLS identifier for the real estate broker or agent.

For that matter, the linking can include establishing a mail box for the listing broker to which any and all electronic communications relating to the listed property are directed, stored and accessed by association with the listing broker or agent identifier, or alternatively establishing a mail box for the listing broker to which any and all electronic communications relating to the listed property are directed, stored and accessed by association with the owner/property identifier. The accessing listing information is carried out in association with the owner/property identifier. For that matter, any listing information accessed is associated with the MLS identifier of the listing broker or agent linked to the real property.

In the alternative embodiment where a particular communication is sent concurrently to both the listing broker/agent and the listing owner, and while the system may be configured to do so, there is no real need for a return notification identifying receipt of same communication by the listing where the communication also is sent to the listing owner concurrently.

In a variation, the invention provides a method of operating a real estate multiple listing service (MLS) including an appointment-offer-notification (AON) function, implemented by a processor server by maintaining a multiple listing service (MLS) database to store and make accessible listing information on real estate properties listed with the MLS, interconnecting a plurality of computers associated with real estate brokers and agents doing business with an MLS, wherein each computer is authorized to search and access listing information on real estate properties in the database, receiving a listing for a real estate property for sale, rent or lease from real estate a broker/agent for listing with the MLS, and linking the listing broker/agent to both the real property and an owner of the real property using one of a broker/agent identifier and an owner/property identifier, directing any and all electronic communications relating to the listed real estate property to the listing broker/agent linked to the listing by the broker/agent identifier or the owner/property identifier and if the listing agent or broker does not respond to an electronic communication concerning the listed real estate property, and upon the occurrence of a predetermined condition, redirecting the electronic communication directly to the owner of the listed property.

In a variation, all electronic requests for an appointment to view the listed real estate property and requests to consider a bone fide offer to purchase the listed real estate property are directed not merely to the listing broker/agent, and then forwarded at a certain condition (e.g., after 1 day) where the listing broker/agent is non-responsive, but to the property owner of the listed property at the time of the broker/agent communication (i.e., the communication is sent to both concurrently). This way the listed property owner in not merely notified of a request to show or bona fide offer for sale after a fixed time period, or upon the occurrence of some other condition where the listing broker/agent is non-responsive to the communication, but immediately (concurrently) with these communications to the listing broker/agent.

Preferably, the interconnecting includes both intra- and Internetwork and the maintaining includes that the database is connected to the processor/server directly, over a network bus such as an Ethernet bus and over the Internet.

Thus, these aspects of the present invention is directed to a programmed product, comprising signal-bearing storage media tangibly embodying a program of machine-readable instructions executable by a digital data processor incorporating the CPU 112 and hardware above, to perform the AON method of the invention.

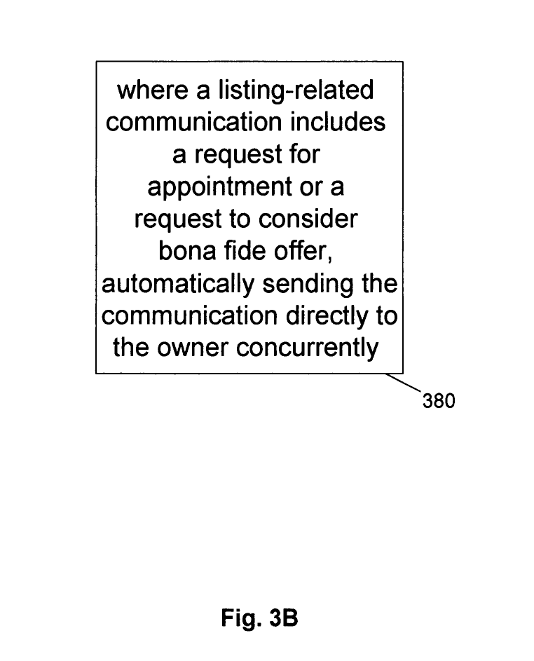

This signal-bearing storage media may include, for example, a RAM contained within the CPU 112, as represented by the fast-access storage for example. Alternatively, the instructions may be contained in another signal-bearing storage media, such as a magnetic data storage diskette 400 (FIG. 4), directly or indirectly accessible by the CPU 112.

Whether contained in the diskette 400, or some other computer readable medium, the processor/server 110 comprising CPU 112, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape). Other suitable signal-bearing media include memory devices in transmission media and instructions stored in formats such as digital and analog and memory devices in communication links and wireless. In an illustrative embodiment of the invention, the machine-readable instructions may comprise software object code. It should also be obvious to one of ordinary skill in the art that the technique of the present invention could be implemented on a network in a variety of configurations.

Hence, the invention includes a computer program product including a processor and a set of processor readable instructions that when executed by the processor execute an appointment-offer-notification (AON) method for managing multiple listing service (MILS) communications relating to an exchange of real estate property listing information.

An embodiment of the AON method includes interconnecting and managing a network of computers associated with MLS member real estate brokers and agents to enable MLS member access to a repository of real estate property listing information for real estate properties listed under contract with the MLS for sale, rent or lease, receiving a listing for a real estate property to sell, rent or lease from a sending broker or agent network computer, linking the listing to the broker or agent associated with said sending network computer that has contracted with an owner of real estate property listed, depositing listing information related to the listed real estate property in the repository to render the listing information network accessible and directing any and all electronic communications relating to the listed real estate property to the listing broker or agent linked to the listing. If the listing agent or broker does not respond to an electronic request for an appointment to view the listed real estate property or request to consider a bone fide offer to purchase the listed real estate property (for example, from a potential purchaser or co-broker (agent) associated with the potential purchaser), redirecting said request directly to the owner of the listed property. Alternatively, where listing-related communications requesting an appointment or making a bona fide offer to purchase are sent to the listing broker/agent, instead of notifying the seller/owner where the listing broker agent is non-responsive only at the occurrence of a condition, i.e., one or two days, either one or both of such particular communications are sent concurrently to both the listing broker/agent and the listing owner. So in this case, where the system may be configured to do so, there is no real need for a return notification identifying receipt of same communication by the listing where the communication also is sent to the listing owner concurrently.

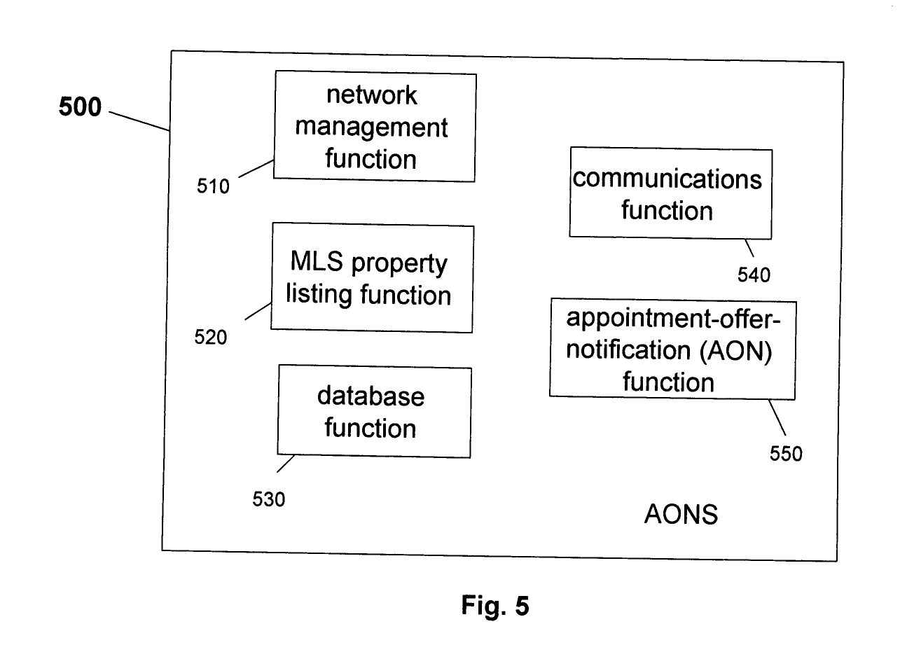

FIG. 5 presents an alternative embodiment of an electronic appointment-offer-notification system (AONS) 500 of the invention. AONS 500 includes a processor (a CPU 112 and a memory 116, 118, 122) operable as a processor/server for managing multiple listing service (MLS) communications relating to an exchange of real estate property listing information, which operate of implement functions or operational sections.

A network management function 510 maintains and manages a network of computers associated with MLS member real estate brokers and agents including enabling access to a repository of real estate property listing information for real estate properties listed under contract with the MLS for sale, rent or lease. An MLS property listing function 520 receives a listing for a real estate property to sell, rent or lease from an MILS member sending broker or agent network computer and linking the listing to the broker or agent associated with said sending network computer who contracted with the real property owner. All MLS member brokers and their agents, including listing brokers/agents and co-broker (agents).

A database function 530 enables depositing listing information related to the real estate property listing in the repository and rendering the listing information network accessible. A communications function 540 directs any and all electronic communications relating to the listed real estate property to the listing broker or agent linked to the listing. Electronic appointment-offer-notification (AON) function 550 monitors all electronic communications and where it detects that a listing agent or broker has not responded to an electronic communication requesting an appointment to view the listed real estate property or presenting a bone fide offer to purchase the listed real estate property, electronically communicating or redirecting said request to the owner of the listed property. The phrase “not responded” is meant to convey a condition where the listing broker/agent is determined to have received a communication with the criteria mentioned, for example, by a metadata, by a script or by a documents template embedded in the communication, and does not respond by a certain condition. The certain condition might include that the broker/agent does not respond after a certain time period, for example, one day, two days, or after two of the same communications, separated by a day, or two days, etc.

Preferably, communications function 540 uses a form that includes fields for specifically identifying at least one of: an attempt to make an appointment to show a property linked to an MLS member broker or agent, an attempt to make an offer to purchase a property linked to an MLS member broker or agent and an attempt to send a letter of intent relating to a property linked to an MLS member broker or agent, and most preferably scans all electronic communications to identify whether the fields are activated by the sender.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

1. An appointment-offer-notification (AON) method, operable in a processor/server, for managing multiple listing service (MLS) communications relating to an exchange of real estate property listing information, comprising:
interconnecting and managing a network of computers associated with MLS member real estate brokers and agents to enable MLS member access to a repository of real estate property listing information for real estate properties listed under contract with the MLS for sale, rent or lease;
receiving a listing for a real estate property to sell, rent or lease from a sending broker or agent network computer;
linking the listing to the broker or agent associated with said sending network computer that has contracted with an owner of real estate property listed;
depositing listing information related to the listed real estate property in the repository to render the listing information network accessible;
directing any and all electronic communications relating to the listed real estate property to the listing broker or agent linked to the listing; and
if the listing agent or broker does not respond to an electronic request for an appointment to view the listed real estate property or request to consider a bone fide offer to purchase the listed real estate property, redirecting said request to the owner of the listed property.

2. The appointment-offer-notification (AON) method as set forth in claim 1, wherein the interconnecting and managing includes creating accounts for the broker or agent seeking to become an MLS member.

3. The appointment-offer-notification (AON) method as set forth in claim 2, wherein the creating includes communicating with a server for a governmental agency empowered to regulate and license real estate brokers and agents in order to verify that the broker or agent seeking MLS membership is licensed and in good standing.

4. The appointment-offer-notification (AON) method as set forth in claim 2, wherein the creating includes assigning an MLS broker or agent identifier to the real estate broker or agent account.

5. The appointment-offer-notification (AON) method as set forth in claim 4, wherein the linking includes assigning the MLS broker or agent identifier to the linked listing.

6. The appointment-offer-notification (AON) method as set forth in claim 1, wherein the linking includes a assigning an owner/property identifier to the linked listing that identifies the owner under contract, the real estate property and the broker or agent.

7. The appointment-offer-notification (AON) method as set forth in claim 1, wherein said redirecting said request for appointment or request to consider a bone fide offer to purchase directly to the owner where the listing agent fails to respond either after at least one 24 hour period or to at least two received requests.

8. The appointment-offer-notification (AON) method as set forth in claim 1, wherein said directing and redirecting require that said request for appointment or request to consider a bone fide offer to purchase include a communication form with fields configured for identification and monitoring said request for appointment or request to consider a bone fide offer to purchase.

9. The appointment-offer-notification (AON) method as set forth in claim 5, wherein the linking includes establishing a mail box for the listing broker to which any and all electronic communications relating to the listed property are directed, stored and accessed by association with the listing broker or agent identifier.

10. The appointment-offer-notification (AON) method as set forth in claim 6, wherein the linking includes establishing a mail box for the listing broker to which any and all electronic communications relating to the listed property are directed, stored and accessed by association with the owner/property identifier.

11. The appointment-offer-notification (AON) method as set forth in claim 1, wherein the redirecting includes generating a return notification upon delivery of any and all communications to the listing real estate broker or agent.

12.-18. (canceled)

19. An electronic appointment-offer-notification system (AONS), comprising a processor and memory operable as a processor/server for managing multiple listing service (MLS) communications relating to an exchange of real estate property listing information, the system comprising:
a network management function that maintains and manages a network of computers associated with MLS member real estate brokers and agents including enabling access to a repository of real estate property listing information for real estate properties listed under contract with the MLS for sale, rent or lease;
an MLS property listing function for receiving a listing for a real estate property to sell, rent or lease from an MLS member sending broker or agent network computer and linking the listing to the broker or agent associated with said sending network computer who contracted with the real property owner;
a database function that enables depositing listing information related to the real estate property listing in the repository and rendering the listing information network accessible;
a communications function that directs any and all electronic communications relating to the listed real estate property to the listing broker or agent linked to the listing; and
an electronic appointment-offer-notification (AON) function that monitors all electronic communications and operates in one of a first mode of operation and a second mode of operation:
in the first mode of operation, the AON function operates to detect that a listing agent or broker has not responded to an electronic communication requesting an appointment to view the listed real estate property or presenting a bone fide offer to purchase the listed real estate property, and in response automatically electronically communicates said communication directly to the owner of the listed property, and
in the second mode of operation, the AON function operates to automatically detect electronic communications to a listing agent or broker that either request an appointment to view the listed real estate property or present a bone fide offer to purchase the listed real estate property, and in response automatically electronically sends said communication to the owner of the listed property.

20. The electronic appointment-offer-notification system (AONS) as set forth in claim 19, wherein the communications function includes using a form that include fields for specifically identifying at least one of: an attempt to make an appointment to show a property linked to an MLS member broker or agent, an attempt to make an offer to purchase a property linked to an MLS member broker or agent and an attempt to send a letter of intent relating to a property linked to an MLS member broker or agent.

21. The electronic appointment-offer-notification system (AONS) as set forth in claim 20, wherein the communications function scans all electronic communications to identify whether said fields are activated.

22. The appointment-offer-notification (AON) method as set forth in claim 10, wherein the redirecting includes generating a return notification upon delivery of any and all communications to the mail box of the listing real estate broker or agent in accordance with the MLS identifier for the real estate broker or agent.

23. The appointment-offer-notification (AON) method as set forth in claim 6, wherein accessing listing information is carried out in association with the owner/property identifier.

24. The appointment-offer-notification (AON) method as set forth in claim 23, wherein any listing information accessed is associated with the MLS identifier of the listing broker or agent linked to the real property.

25. A method of operating a real estate multiple listing service (MLS) including an appointment-offer-notification (AON) function, implemented by a processor server, comprising:
maintaining a multiple listing service (MLS) database to store and make accessible listing information on real estate properties listed with the MLS;
interconnecting a plurality of computers associated with real estate brokers and agents doing business with an MLS, wherein each computer is authorized to search and access listing information on real estate properties in the database;
receiving a listing for a real estate property for sale, rent or lease from real estate a broker/agent for listing with the MLS, and linking the listing broker/agent to both the real property and an owner of the real property using one of a broker/agent identifier and an owner/property identifier; and
directing any and all electronic communications relating to the listed real estate property to the listing broker/agent linked to the listing by the broker/agent identifier or the owner/property identifier;
wherein electronic communications directed to the listing broker/agent that either request an appointment to show the listed property or include a bona fide offer to purchase are automatically recognized and sent concurrently to the owner of the listed property.

26. The method of operating a real estate multiple listing service (MLS) as set forth in claim 25, wherein the interconnecting includes both intra- and Internetwork.

27. The method of operating a real estate multiple listing service (MLS) as set forth in claim 25, wherein the maintaining includes that the database is connected to the processor/server directly, over a network bus such as an Ethernet bus and over the Internet.

28. A computer program product including a processor and a set of processor readable instructions that when executed by the processor execute an appointment-offer-notification (AON) method for managing multiple listing service (MLS) communications relating to an exchange of real estate property listing information, comprising:
interconnecting and managing a network of computers associated with MLS member real estate brokers and agents to enable MLS member access to a repository of real estate property listing information for real estate properties listed under contract with the MLS for sale, rent or lease;
receiving a listing for a real estate property to sell, rent or lease from a sending broker or agent network computer;
linking the listing to the broker or agent associated with said sending network computer that has contracted with an owner of real estate property listed;
depositing listing information related to the listed real estate property in the repository to render the listing information network accessible;
directing any and all electronic communications relating to the listed real estate property to the listing broker or agent linked to the listing; and
one of:
wherein if the listing agent or broker does not respond to an electronic communication either requesting an appointment to view the listed real estate property or requesting a bona fide offer to purchase the listed real estate property, automatically recognizing and redirecting said electronic communication request directly to the owner of the listed property, and
wherein electronic communications directed to the listing broker/agent that either request an appointment to show the listed property or include a bona fide offer to purchase the listed property are automatically recognized and sent concurrently to the owner of the listed property.
